(19) United States
(12) Patent Application Publication
(10) Pub. No.: US 2011/0176611 A1
(43) Pub. Date: Jul. 21, 2011

(54) METHODS FOR DECODER-SIDE MOTION VECTOR DERIVATION

(76) Inventors: Yu-Wen Huang, Taipei City (TW); Yu-Pao Tsai, Kaohsiung County (TW); Chih-Ming Fu, Hsinchu City (TW); Shaw-Min Lei, Taipei County (TW)

(21) Appl. No.: 12/826,693

(22) Filed: Jun. 30, 2010

Related U.S. Application Data
(60) Provisional application No. 61/295,227, filed on Jan. 15, 2010.
(60) Provisional application No. 61/306,608, filed on Feb. 22, 2010.

(51) Int. Cl. H04N 7/26

(52) U.S. Cl. 375/240.16; 375/E07.123

(57) ABSTRACT

An exemplary method for decoder-side motion vector derivation (DMVD) includes: checking a block size of a current block to be encoded and accordingly generating a checking result; and utilizing a DMVD module to refer to the checking result to control conveyance of first DMVD control information which is utilized for indicating whether a DMVD coding operation is employed to encode the current block. When the checking result indicates a predetermined criterion is satisfied, the first DMVD control information is sent in a bitstream; otherwise, the first DMVD control information is not sent.

### CROSS REFERENCE TO RELATED APPLICATIONS

This application claims the benefit of U.S. Provisional Application No. 61/295,227, filed on Jan. 15, 2010, and U.S. Provisional Application No. 61/306,608, filed on Feb. 22, 2010. The entire contents of the related applications are included herein by reference.

### BACKGROUND

The disclosed embodiments of the present invention relate to data encoding/decoding, and more particularly, to methods for decoder-side motion vector derivation.

In video coding, the temporal and spatial correlation found in image sequences is exploited for bit-rate reduction/coding efficiency improvement. In general, motion compensated inter-frame prediction accounts for a significant percentage of the final compression efficiency. The motion information such as motion vector data and reference picture indices is derived at the encoder and coded into a bitstream, so the decoder can simply perform motion compensated prediction based on the decoded motion information. However, the coding of motion information requires a significant amount of bit-rate. Therefore, a decoder-side motion vector derivation (DMVD) scheme is proposed.

The motion information may be determined using a template matching (TM) algorithm at the encoder and the decoder. Besides, additional flags are coded for different macroblock types of predictive (P) pictures to signal the usage of the DMVD. FIG. 1 is a diagram illustrating a conventional TM scheme for P pictures. Generally speaking, the conventional TM exploits correlation between the pixels from blocks adjacent to the prediction target block and those in already reconstructed reference picture(s). As shown in FIG. 1, a DMVD target block 102 in a current picture has a block size of N×N pixels, and is part of a macroblock/macroblock partition 106; in addition, a reverse L-shaped template 104 is defined extending M pixels from the top and the left of the DMVD target block 102. Here, reverse L-shape is a mirror image of L-shape across a horizontal axis. It should be noted that the reverse L-shaped template 104 only covers reconstructed pixels. For clarity, the reconstructed pixels in the current picture are represented by oblique lines. Then, a small search range centered at a candidate motion vector (MV) is defined in each reference picture. At least one displaced template region in one or more reconstructed reference pictures temporally preceding the current picture is determined by minimizing a distortion value (e.g., the sum of absolute differences, SAD) between the reverse L-shaped template 104 in the current picture and one displaced template in the reconstructed reference picture(s). As shown in FIG. 1, the displaced template 108 is found due to the smallest distortion between the reverse L-shaped template 104 and the displaced template 108. In this way, a final motion vector 110 for the DMVD target block 102 can be successfully determined by TM.

RWTH Aachen University first proposed a DMVD work in VCEG-AG16 and VCEG-AH15r1. The supported macroblock (MB) types include P_SKIP MB, P_L0_{—}16×16 MB, P_L0_L0_{—}16×8 MB, P_L0_L0_{—}8×16 MB, and P_{—}8×8 MB with four P_L0_{—}8×8 sub-macroblocks (SubMBs). Regarding a macroblock under a skip mode (i.e., P_SKIP MB), N is equal to 16, M is equal to 4, and a single reference picture is used for finding the final motion vector 110 of the DMVD target block 102. Besides, one flag tm_skip_active_flag which specifies if the current 16×16 MB uses DMVD coding or conventional motion vector coding is sent per MB when SKIP_MV is not equal to TM_MV, where SKIP_MV is a motion vector as defined by H.264 standard, and TM_MV is the final motion vector found using TM mentioned above. Therefore, when a decoder is decoding a macroblock, the decoder has to perform TM for determining the TM_MV and then compare the found TM_MV with SKIP_MV to judge whether there is one flag tm_skip_active_flag coded in a bitstream generated from the encoder. Regarding macroblocks under a non-skip mode (i.e., P_L0_{—}16×16 MB, P_L0_L0_{—}16×8 MB, P_L0_L0_{—}8×16 MB, and P_{—}8×8 MB with four P_L0_{—}8×8 SubMBs), multiple reference pictures are used for finding a final motion vector of the DMVD target block 110. In regard to a P_L0_{—}16×16 MB, N is equal to 16, M is equal to 4, and one flag tm_active_flag which specifies if the current 16×16 MB uses DMVD coding or conventional motion vector coding is sent per 16×16 MB. In regard to a P_L0_L0_{—}16×8 MB, N is equal to 8, M is equal to 4, and one flag tm_active_flag which specifies if the current 16×8 MB partition uses DMVD coding or conventional motion vector coding is sent per 16×8 MB partition. In regard to a P_L0_{—}8×16 MB, N is equal to 8, M is equal to 4, and one flag tm_active_flag which specifies if the current 8×16 MB partition uses DMVD coding or conventional motion vector coding is sent per 8×16 MB partition. In regard to a P_L0_{—}8×8 SubMB, N is equal to 4, M is equal to 4, and one flag tm_active_flag which specifies if the current 8×8 SubMB uses DMVD coding or conventional motion vector coding is sent per 8×8 SubMB; moreover, 8×8 transform is not allowed due to N is smaller than 8. As one can see, the template size M of the conventional reverse L-shaped template is the same (i.e., M=4) for all supported block types of the TM scheme.

During the TM stage, the distortion value, such as the sum of absolute differences (SAD), for the reverse L-shaped template 104 is calculated as cost for each candidate motion vector found in the search range. Instead of just identifying one final motion vector with the minimum cost under a single-hypothesis prediction, a set of final motion vectors with lowest costs may be determined for the DMVD target block 102 under a multi-hypothesis prediction. Next, in accordance with the conventional design, a simple average operation is employed to determine a final motion vector.

To put it simply, regarding a skipped macroblock under a skip mode, a single reference picture and a single hypothesis are used, and an integer-pel full search is performed for checking a plurality of candidate motion vectors according to a search range centered at a candidate motion vector. In addition, a sub-pel refinement may be applied to the detected integer MV. Regarding a non-skipped macroblock, multiple reference pictures and multiple hypotheses may be used, and an integer-pel full search is performed for checking a plurality of candidate motion vectors according to the multiple reference pictures and multiple hypotheses. In addition, a sub-pel refinement may be applied to each detected integer MV, and a final motion vector is derived by a simple average calculation applied to the sub-pel motion vector predictions.

In order to further reduce the number of search positions, a candidate-based search is also proposed. As shown in FIG. 2, the motion vectors of neighboring reconstructed blocks A and C (if the top-right reconstructed block C is available) or A and C′ (if the top-right reconstructed block C is not available) are used as candidate motion vectors for searching a final motion vector of the DMVD target block 202. In other words, compared to the aforementioned TM full search scheme, the candidate-based search scheme reduces the number of search positions to 2 per reference picture. In addition, a sub-pel refinement may also be skipped or applied to each integer MV found using the candidate-based search.

As mentioned above, the flag tm_skip_active_flag for one P_SKIP MB is not coded in the bitstream when SKIP_MV is found equal to TM_MV at the encoder side. When parsing the bitstream generated by the encoder, the decoder therefore needs to perform the TM operation to determine TM_MV and then check if SKIP_MV is equal to TM_MV. When SKIP_MV is equal to TM_MV, the decoder knows that no flag tm_skip_active_flag for the P_SKIP MB is coded in the bitstream. However, when there is one erroneous reference pixel in the reference picture, the derived TM_MV may be incorrect. In a case where the flag tm_skip_active_flag for the P_SKIP MB is coded in the bitstream but TM_MV is found equal to SKIP_MV due to the erroneous reference pixel, the decoder will erroneously judge that there is no flag tm_skip_active_flag sent for the P_SKIP MB. As a result, the decoder may fail to parse rest of the current picture and even following pictures if there are no resynchronization markers at beginnings of pictures. If the prior DMVD design is modified to always send the flag tm_skip_active_flag for each P_SKIP MB for solving the above-mentioned parsing problem, the coding efficiency is significantly degraded as one flag tm_skip_active_flag/tm_active_flag is always sent for each supported MB type.

The prior DMVD design supports P slices (pictures) only; besides, the prior DMVD design lacks flexibility. For example, the template used in the TM full search is limited to a reverse L-shaped template with a constant template size, almost all of the supported MB types require flags coded in the bitstream, the highest MV precision is limited to ¼-pel MV precision, and the candidate-based search only uses MVs of the left block and the top-right block (or top-left block).

### SUMMARY

In accordance with exemplary embodiments of the present invention, methods for decoder-side motion vector derivation (DMVD) are proposed to solve the above-mentioned problems.

According to one aspect of the present invention, an exemplary method for decoder-side motion vector derivation (DMVD) includes: checking a block size of a current block to be encoded and accordingly generating a checking result; and utilizing a DMVD module to refer to the checking result to control conveyance of first DMVD control information which is utilized for indicating whether a DMVD coding operation is employed to encode the current block. When the checking result indicates a predetermined criterion is satisfied, the first DMVD control information is sent in a bitstream; otherwise, the first DMVD control information is not sent.

According to another aspect of the present invention, an exemplary method for decoder-side motion vector derivation (DMVD) includes: utilizing a DMVD module to set a DMVD target block size by referring to a transform block size for a current block, wherein the DMVD target block size is consistent with the transform block size; and determining a final motion vector of a DMVD target block.

According to another aspect of the present invention, an exemplary method for decoder-side motion vector derivation (DMVD) includes: setting a DMVD motion vector (MV) precision by a DMVD module, comprising enabling a specific MV precision as the DMVD MV precision, wherein the specific MV precision is different from a non-DMVD MV precision; and determining a final motion vector of a DMVD target block according to the DMVD MV precision.

According to another aspect of the present invention, an exemplary method for decoder-side motion vector derivation (DMVD) includes: utilizing a DMVD module to select motion vectors of coded blocks for a DMVD target block, wherein the coded blocks and the DMVD target block may located in a same picture or different pictures; processing the motion vectors of the coded blocks to compute a candidate motion vector; and determining a final motion vector of the DMVD target block according to at least the candidate motion vector.

According to another aspect of the present invention, an exemplary method for decoder-side motion vector derivation (DMVD) includes: utilizing a DMVD module to select a motion vector of at least one block as a candidate motion vector of a DMVD target block, wherein the at least one block and the DMVD target block are located in different pictures; and determining a final motion vector of the DMVD target block according to at least the candidate motion vector.

According to another aspect of the present invention, an exemplary method for decoder-side motion vector derivation (DMVD) includes: utilizing a DMVD module to select a template for a DMVD target block, wherein the template and the DMVD target block are located in a same picture, and the template is a rectangular-shaped template defined by extending M pixels from the top of the DMVD target block; and searching at least one reference picture for a final motion vector of the DMVD target block by performing a template matching operation according to the template.

According to another aspect of the present invention, an exemplary method for decoder-side motion vector derivation (DMVD) includes: searching at least one reference picture for a plurality of final motion vectors of a DMVD target block according to a multi-hypothesis prediction; utilizing a DMVD module to calculate weighting factors of the final motion vectors by referring to distortion values respectively corresponding to the final motion vectors; and determining a final prediction block by blending prediction blocks of the final motion vectors according to the calculated weighting factors.

According to another aspect of the present invention, an exemplary method for decoder-side motion vector derivation (DMVD) includes: searching at least one reference picture for a plurality of candidate motion vectors of a DMVD target block according to a multi-hypothesis prediction; utilizing a DMVD module to select multiple final motion vectors from the candidate motion vectors, blending multiple templates of the multiple final motion vectors according to predefined weighting factors to generate a blended template, and calculating a distortion value between a template of a current picture and the blended template of the at least one reference picture; and determining a final prediction block to be the blending result from multiple prediction blocks of the multiple final motion vectors that can minimize the distortion value.

According to another aspect of the present invention, an exemplary method for decoder-side motion vector derivation (DMVD) includes: utilizing a DMVD module to generate at least one virtual reference picture according to at least one original reference picture; and searching the at least one original reference picture and the at least one virtual reference picture for a final motion vector of a DMVD target block.

According to another aspect of the present invention, an exemplary method for decoder-side motion vector derivation (DMVD) includes: performing a DMVD coding operation at an encoder; and sending search control information derived from the DMVD coding operation performed at the encoder to a decoder such that there is asymmetric DMVD search complexity between the encoder and the decoder.

According to another aspect of the present invention, an exemplary method for decoder-side motion vector derivation (DMVD) includes: utilizing a DMVD module to determine a motion vector of a first DMVD target block according to a first property; and utilizing the DMVD module to determine a motion vector of a second DMVD target block according to a second property different from the first property. Embodiments of the first property and second property are different matching criteria, different search position patterns, different MV precisions, different numbers of hypotheses, different template shape for template matching, different blending schemes, and different numbers of virtual reference pictures.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional TM scheme for P pictures.

FIG. 2 is a diagram illustrating neighboring reconstructed blocks with motion vectors used as candidate motion vectors for a DMVD target block according to a prior candidate-based search scheme.

FIG. 3 is a diagram illustrating a data processing system according to an exemplary embodiment of the present invention.

FIG. 4 is a diagram showing a current block and a plurality of adjacent blocks whose DMVD control information is referenced for determining how the DMVD control information of the current block is coded.

FIG. 5 is a diagram illustrating motion vectors of neighboring blocks that are selected as candidate motion vector of a DMVD target block according to an exemplary fast search scheme of the present invention.

FIG. 6 is a diagram illustrating motion vectors of blocks in a reference picture that are selected as candidate motion vectors of a DMVD target block in a current picture according to another exemplary fast search scheme of the present invention.

FIG. 7 is a diagram illustrating a first exemplary template design of the present invention.

FIG. 8 is a diagram illustrating a second exemplary template design of the present invention.

FIG. 9 is a diagram illustrating a plurality of virtual reference pictures and a plurality of original reference pictures according to an exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The present invention proposes exemplary DMVD designs to solve the aforementioned parsing and flexibility problems encountered by the prior DMVD design. FIG. 3 is a diagram illustrating a data processing system 300 according to an exemplary embodiment of the present invention. The data processing system 300 includes an encoder 302 and a decoder 312, where a bitstream generated from the encoder 302 is transmitted to the decoder 312 via a transmission means 301. For example, the transmission means 301 may be a storage medium or a wired/wireless network. The encoder 302 includes a DMVD module 304 and other modules 306 coupled to the DMVD module 304, where the DMVD module 304 is utilized for performing an exemplary DMVD method of the present invention to thereby generate a final motion vector MV_1 for each DMVD target block, and other modules 306 receive the final motion vector MV_1 of each DMVD target block and generate a bitstream. For example, other modules 306 may include transform, quantization, inverse quantization, inverse transform, entropy encoding, etc. The decoder 312 includes a DMVD module 314 and other modules 316 coupled to the encoder 302, where the DMVD module 314 is utilized for performing the exemplary DMVD method of the present invention to generate a final motion vector MV_2 for each DMVD target block, and other modules 316 receive the final motion vector MV_2 of each DMVD target block and generate reconstructed pictures. For example, other modules 316 may include inverse transform, inverse quantization, entropy decoding, etc. Please note that each module can be a software implementation, a hardware implementation, or a combined implementation of software and hardware. Ideally, a final motion vector MV_1 found by the encoder 302 for a specific DMVD target block should be identical to a final motion vector MV_2 found by the decoder 312 for the same specific DMVD target block. Details of exemplary embodiments of the DMVD method of the present invention are described as follows.

The DMVD module 304 checks a block size of a current block to be encoded and accordingly generates a checking result. In practice, checking a block size can be achieved by detecting the block size or detecting a macroblock type (MB type), so the checking result is generated by comparing the block size with a predetermined block size or comparing the MB type with a predetermined MB type. Next, the DMVD module 304 refers to the checking result to control conveyance of DMVD control information which is utilized for indicating whether a DMVD coding operation is employed to encode the current block. When the checking result indicates a predetermined criterion is satisfied, for example, when the block size or MB type is found identical to the predetermined block size or predetermined MB type, the DMVD control information for the current block is sent; otherwise, the DMVD control information is not sent. For example, the DMVD control information is a flag tm_active_flag, and the predetermined criterion is set to be a predetermined block size of 16×16. Therefore, when the DMVD is allowed to be used and the block size of the current block is 16×16, the flag tm_active_flag is sent (i.e., coded into the bitstream) by the encoder 302. If the DMVD scheme is employed, the flag tm_active_flag is set to “1”. Thus, there is no need to send the reference picture index and the motion vector, and the prediction direction is indicated by the macroblock type codeword. In some embodiments, the block size of the DMVD target block N×N is set to be identical to the transform block size (e.g. 4×4 or 8×8). However, if the conventional motion vector coding scheme is employed, the flag tm_active_flag is set to “0”. It should be noted that the exemplary DMVD design supports forward (or list 0) prediction, backward (or list 1) prediction, and bi-prediction. Thus, the forward prediction result and the backward prediction result are derived independently. When the bi-prediction mode is selected, the bi-prediction result can be simply derived from the forward prediction result and the backward prediction result for lower complexity or can be derived with simultaneously considering forward prediction and backward prediction for higher coding efficiency.

The flag tm_active_flag is sent in the bitstream only when the checking result indicates that the predetermined criterion is satisfied, for example, when the block size is 16×16. Thus, when DMVD is not chosen for other block sizes, the coding efficiency can be improved as the flag tm_active_flag is not sent for other block sizes. Moreover, when parsing the bitstream generated by the encoder 302, the decoder 312 is not required to perform the template matching operation to find a final motion vector first and then check if the flag tm_active_flag is sent. In this way, no parsing problem occurs when any part of the reference pictures is lost or corrupted. The aforementioned parsing problem encountered by the prior DMVD design is therefore solved.

It should be noted that the exemplary DMVD method may also support extended macroblocks each being larger than a 16×16 macroblock. For example, an extended macroblock has a block size equal to 64×64 pixels or 32×32 pixels.

Regarding a DMVD skipped block that does not send any residue, in addition to sending the flag tm_active_flag as DMVD control information, the encoder 302 may send another DMVD control information which is utilized for indicating whether a DMVD skip mode is employed. For example, when the flag tm_active_flag indicates that the DMVD coding operation is employed (i.e., tm_active_flag==1), a flag tm_skip_active_flag is sent. When the DMVD coding scheme is used, the flag tm_skip_active_flag is set to “1” if the block is a DMVD skipped block, and the flag tm_skip_active_flag is set to “0” if the block is a DMVD non-skipped block. For a 16×16 DMVD skipped block, the DMVD target block size is set to be 16×16 pixels, and for a 16×16 DMVD non-skipped block, the DMVD target block size is set to be consistent with its transform size. With conveyance of the flags tm_active_flag and tm_skip_active_flag, the coding efficiency may be further improved.

In contrast to the prior DMVD design with a highest MV precision limited to ¼-pel MV precision, the exemplary DMVD design of the present invention can support a higher MV precision, such as a ⅛-pel MV precision. In another alternative design, a highest MV precision is either ¼-pel MV precision for non-DMVD blocks or ⅛-pel MV precision for DMVD blocks. Therefore, in addition to sending the DMVD control information (e.g., the flag tm_active_flag) and/or another DMVD control information (e.g., the flag tm_skip_active_flag) in the bitstream, the encoder 302 may send yet another DMVD control information (e.g., a flag tm_mv_res_flag) which is utilized for indicating whether a specific MV precision (e.g., ⅛-pel MV precision), different from a non-DMVD MV precision, is enabled. For example, when the flag tm_active_flag indicates that the DMVD coding operation is employed (i.e., tm_active_flag==1), the flag tm_mv_res_flag is sent at slice or sequence level to indicate the MV precision for DMVD MV. In the case where DMVD MV precision is allowed to be higher than the precision of non-DMVD MVs when reconstructing DMVD mode, DMVD MVs may be truncated to the same precision as non-DMVD MVs (e.g. ¼-pel) when storing DMVD mode for later MV prediction.

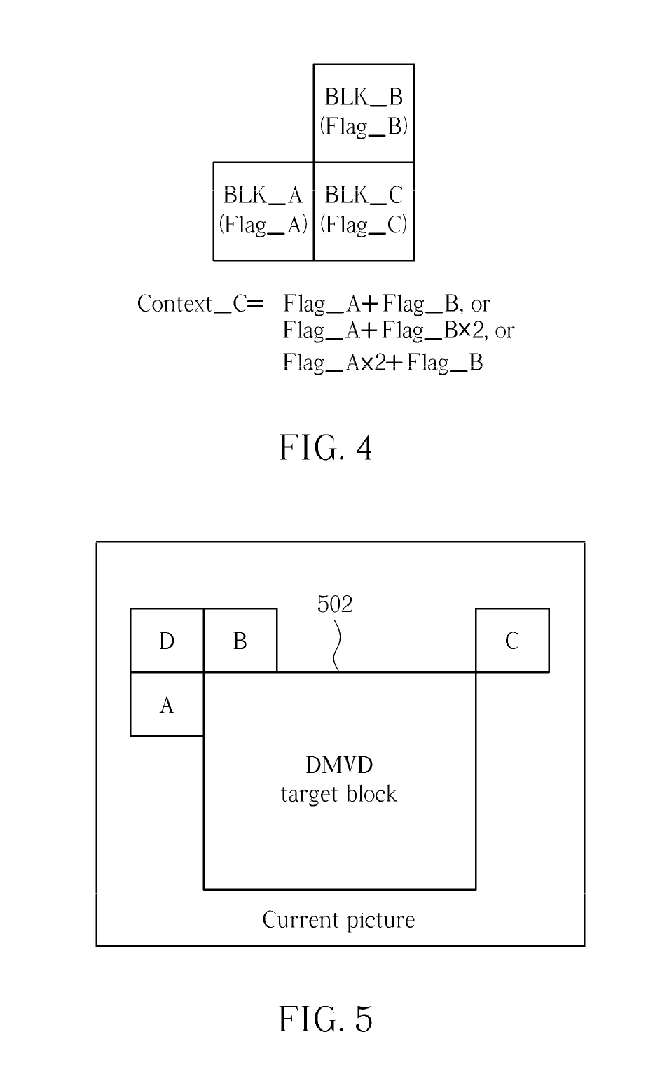

As mentioned above, the DMVD control information (e.g., the flag tm_active_flag) is sent in the bitstream when the block size or MB type of a current block to be encoded is identical to a predetermined block size or MB type (e.g., 16×16/32×32/64×64). The DMVD control information is coded into the bitstream by an entropy encoding module (not shown) within other modules 306 of the encoder 302. For example, a context-adaptive entropy coding operation, such as context-based adaptive binary arithmetic coding (CABAC), may be performed by the entropy encoding module at the encoder 302. An exemplary embodiment of the present invention proposes an improved context design for improving the coding efficiency without significantly increasing the computational complexity. FIG. 4 is a diagram showing a current block BLK_C and a plurality of adjacent blocks BLK_A and BLK_B. Each of the blocks BLK_A, BLK_B and BLK_C has a block size identical to the predetermined block size. Thus, flags Flag_A, Flag_B, and Flag_C, each being the aforementioned flag tm_active_flag for indicating whether the DMVD coding operation is employed, are generated and then coded into the bitstream. Taking the encoding of the flag Flag_C for example, the context of the current block BLK_C can be determined according to flags Flag_A and Flag_B of the adjacent blocks BLK_A and BLK_B which are processed prior to the current block BLK_C. For example, the context Context_C can be calculated according to following equation.

Context_{—}C=Flag_{—}A+Flag_{—}B (1)

The context of the current block BLK_C is set to 0 if both of the flags Flag_A and Flag_B are 0's. The context of the current block BLK_C is set to 2 if both of the flags Flag_A and Flag_B are 1's. The context of the current block BLK_C is set to 1 if one of the flags Flag_A and Flag_B is 1 and the other of the flags Flag_A and Flag_B is 0 (i.e., Flag_A=1 and Flag_B=0, or Flag_A=0 and Flag_B=1). To distinguish which one of the flags Flag_A and Flag_B is 1, the context Context_C may be calculated according to one of the following equations.

Context_{—}C=Flag_{—}A+Flag_{—}B*2 (2)

Context_{—}C=Flag_{—}A*2+Flag_{—}B (3)

In a case where equation (2) is used, the context of the current block BLK_C is set to 1 if the flag Flag_A is 1 and the other flag Flag_B is 0, and the context of the current block BLK_C is set to 2 if the flag Flag_A is 0 and the other flag Flag_B is 1. In another case where equation (3) is used, the context of the current block BLK_C is set to 1 if the flag Flag_A is 0 and the other flag Flag_B is 1, and the context of the current block BLK_C is set to 2 if the flag Flag_A is 1 and the other flag Flag_B is 0.

Briefly summarized, when a block size of a current block is found identical to a predetermined block size, a context-adaptive entropy coding operation is performed upon DMVD control information of the current block according to DMVD control information of a plurality of previously coded blocks each having a block size found identical to the predetermined block size.

As mentioned above, additional DMVD control information (e.g., tm_skip_active_flag or tm_mv_res_flag) is sent when the DMVD coding is employed. Provided that each of the aforementioned flags Flag_A, Flag_B, and Flag_C is a flag tm_skip_active_flag, the context Context_C may be similarly calculated according to one of the above equations (1), (2) and (3). In addition, provided that each of the aforementioned flags Flag_A, Flag_B, and Flag_C is a flag tm_mv_res_flag, the context Context_C may be similarly calculated according to one of the above equations (1), (2) and (3).

Regarding the exemplary TM operation performed by the DMVD module 304/314, an integer-pel full search may be applied to a search range in each reference picture, where the search range is centered at an H.264 MV Predictor (MVP) with a non-integer MV precision (e.g., ¼-pel MV precision) truncated to an integer-pel MV precision. Besides, a sub-pel refinement, such as ½-pel refinement or ¼-pel refinement, may be applied to an integer motion vector found using the integer-pel full search. It should be noted that the DMVD module 304/314 may set a DMVD target block size of a DMVD target block by referring to a transform block size for a current block (e.g., a 16×16/32×32/64×64 macroblock), where the DMVD target block size is consistent with the transform block size (e.g., 2×2, 4×4, or 8×8). Next, the DMVD module 304/314 determines a final motion vector of the DMVD target block within the current block. As the DMVD target block size is now guaranteed to be consistent with the transform block size, the integer transform operation can use any of the available transform block sizes, including 4×4 and 8×8.

As mentioned above, a localized (macroblock-based) adaptive MV precision may be adopted according to the actual design consideration. However, it should be noted that the adaptive MV precision may be controlled at a slice or sequence level without additional syntax change at the macroblock level. For example, regarding each frame/picture, when the motion vector is determined by DMVD, the ⅛-pel MV precision is adopted for finding a final motion vector for each DMVD target block; however, when the motion vector is determined by conventional non-DMVD means, the ¼-pel MV precision is adopted.

To put it simply, the DMVD module 304/314 sets a DMVD MV precision by enabling a specific MV precision (e.g., ⅛-pel MV precision) as the DMVD MV precision, where the specific MV precision (e.g., ⅛-pel MV precision) is different from a non-DMVD MV precision (e.g., integer-pel MV precision, ½-pel MV precision, or ¼-pel MV precision), and determines a final motion vector of a DMVD target block according to the DMVD MV precision. Thus, any DMVD application using a specific MV precision different from the non-DMVD MV precision obeys the spirit of the present invention.

As the final motion vector found using DMVD with the specific MV precision may be utilized for determining a candidate motion vector of a next block which may be a non-DMVD block. To reuse the definition of motion vector prediction in H.264, the DMVD module 304/314 may adjust the final motion vector with the specific MV precision (e.g., ⅛-pel MV precision) by truncating the specific MV precision to a non-DMVD MV precision (e.g., ¼-pel MV precision), and then store the adjusted motion vector with the non-DMVD MV precision. However, this is for illustrative purposes only. For example, if an integer-pel full search is employed for finding a final motion vector of the next block which is a DMVD block, the final motion vector of the current DMVD block that has the specific MV precision (e.g., ⅛-pel MV precision) is not required to have the higher MV precision truncated to a non-DMVD MV precision since the final motion vector with the specific MV precision will be adjusted to have the higher MV precision truncated to an integer MV precision due to the integer-pel full search requirement.

In general, the DMVD uses information derived from reconstructed pixels adjacent to a DMVD target block having non-reconstructed pixels to find a final motion vector of the DMVD target block. Therefore, the similarity between the non-reconstructed pixels of the DMVD target block and the adjacent reconstructed pixels dominates the accuracy of the found motion vector of the DMVD target block. That is, a motion vector found using a higher MV precision (e.g., ⅛-pel MV precision) may not be guaranteed to be more accurate than a motion vector found using a lower MV precision (e.g., ¼-pel MV precision). Based on experimental results, it is found that using ⅛-pel MV precision for low resolution videos tends to have better coding efficiency. Therefore, the DMVD module 304/314 may set a proper DMVD MV precision according to a resolution of an input video. For example, the specific MV precision different from any non-DMVD MV precision is enabled as the DMVD MV precision for the input video with a first resolution (e.g., CIF/WVGA/SVGA), whereas a non-DMVD MV precision is enabled as the DMVD MV precision for the input video with a second resolution (e.g., 720P/1080P) higher than the first resolution.

The aforementioned integer-pel full search has to check a plurality of candidate motion vectors found according to a search range in each reference picture. For example, assuming that the search range is defined by [−S,+S]×[−S,+S] with a center pointed to by an H.264 MVP, R*(2S+1)² candidate pixels have to be examined to find at least one motion vector with lower distortion estimated using the sum of squared differences (SSD) or the sum of absolute differences (SAD), where R represents the number of reference pictures. If at least one of the sub-pel refinement and multi-hypothesis prediction is employed, more candidate pixels will be examined. To reduce the search burden and increase the search flexibility of the DMVD module 304/314, the present invention proposes a fast search scheme which tries multiple candidate motion vector derived from coded blocks in the current picture where the DMVD target block is located and/or coded blocks in one or more reference pictures.

In one exemplary embodiment of the fast search scheme, the DMVD module 304/314 selects a motion vector of at least one neighboring block of a DMVD target block as a candidate motion vector of the DMVD target block, wherein the at least one neighboring block and the DMVD target block are located in a same picture, and the at least one neighboring block includes a top block directly above the DMVD target block. For example, the motion vectors MV_A, MV_B, and MV_C of the blocks A, B, and C, as shown in FIG. 5, are selected as candidate motion vectors of the DMVD target block 502 if the top-right block C is available. If the top-right block C is not available, the motion vectors MV_A, MV_B, and MV_D of the blocks A, B, and D are selected as candidate motion vectors of the DMVD target block 502. Next, the DMVD module 304/314 determines a final motion vector of the DMVD target block 502 according to the candidate motion vectors. It should be noted that the sub-pel refinement, such as ½-pel refinement, ¼-pel refinement or ⅛-pel refinement, may be applied to a single integer-pel motion vector under a single-hypothesis prediction or multiple integer-pel motion vectors under a multi-hypothesis prediction.

In another exemplary embodiment of the fast search scheme, the DMVD module 304/314 tries multiple candidate motion vectors including at least a processed or calculated MV for a DMVD target block. First, the DMVD module 304/314 selects motion vectors of coded blocks for a DMVD target block. The coded blocks may be located in the same picture as the DMVD target block, or the coded blocks may be located in one or more reference pictures. In some other embodiments, at least one of the coded blocks is located in the same picture and at least one of the coded blocks is located in the reference picture(s). Next, the DMVD module 304/314 processes the motion vectors of the coded blocks to compute a candidate motion vector. For example, the candidate motion vector is a median of the motion vectors of the coded blocks. For example, if the top-right block C is available, the motion vectors MV_A, MV_B, and MV_C of the blocks A, B, and C are selected, and a median of the motion vectors MV_A, MV_B, and MV_C is calculated as one candidate motion vector. If the top-right block C is not available, the motion vectors MV_A, MV_B, and MV_D of the blocks A, B, and D are selected, and a median of the motion vectors MV_A, MV_B, and MV_D is calculated as one candidate motion vector. The DMVD module 304/314 determines a final motion vector of the DMVD target block 502 according to at least a candidate motion vector derived from processing or calculating the motion vectors of the coded blocks. It should be noted that the sub-pel refinement, such as ½-pel refinement, ¼-pel refinement, or ⅛-pel refinement, may be applied to a single integer-pel motion vector under a single-hypothesis prediction or multiple integer-pel motion vectors under a multi-hypothesis prediction.

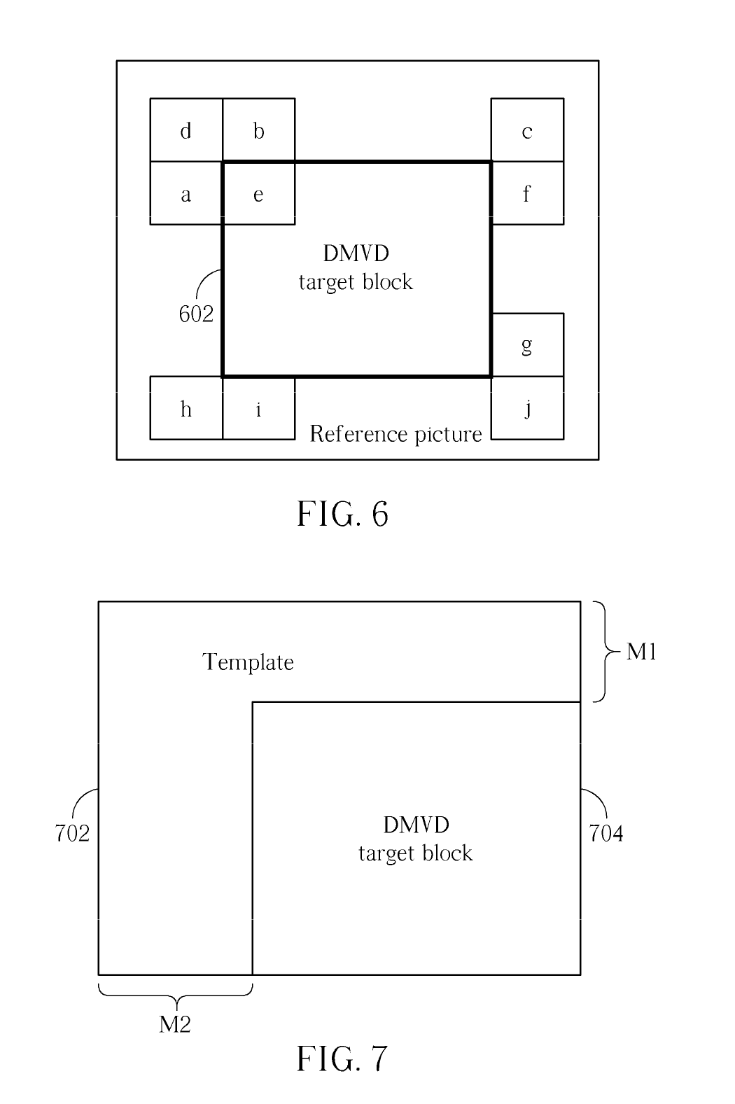

In yet another exemplary embodiment of the fast search scheme, the DMVD module 304/314 selects a motion vector of at least one block as a candidate motion vector of a DMVD target block, wherein the at least one block and the DMVD target block are located in different pictures. Please refer to FIG. 6 in conjunction with FIG. 5. By way of example, but not limitation, the motion vectors MV_a-MV_j of the blocks a-j, as shown in FIG. 6, are selected as candidate motion vectors of the DMVD target block 502 in the current frame, where the block e is within a collocated DMVD target block 602 in the reference picture, and blocks a-d and f-j are adjacent to the collocated DMVD target block 602. Next, the DMVD circuit 304/314 determines a final motion vector of the DMVD target block 502 in the current picture according to the candidate motion vectors. It should be noted that the sub-pel refinement, such as ½-pel refinement, ¼-pel refinement or ⅛-pel refinement, may be applied to a single integer-pel motion vector under a single-hypothesis prediction or multiple integer-pel motion vectors under a multi-hypothesis prediction.

Please note that the selected motion vectors acting as candidate motion vectors of the DMVD target block may be any combination of the fast search schemes proposed in above exemplary embodiments. For example, motion vectors MV_A, MV_B, and MV_C of the blocks A, B, and C in the current picture, a median of the motion vectors MV_A, MV_B, and MV_C, and motion vectors MV_a-MV_j of the blocks a-j in the reference picture are all selected as candidate motion vectors for deriving a final motion vector of the DMVD target block 502 in the current picture.

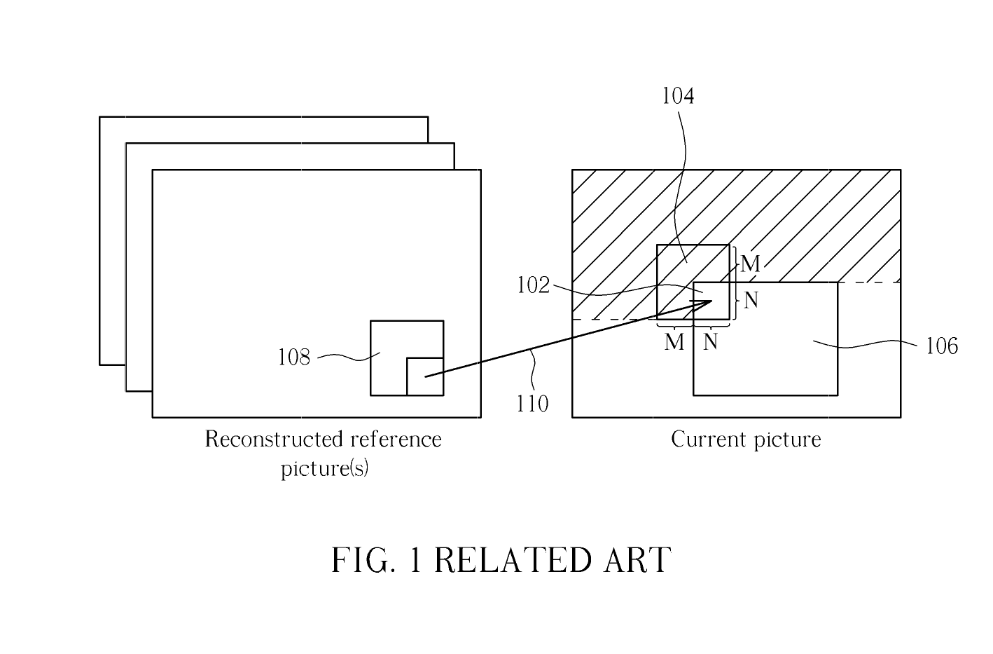

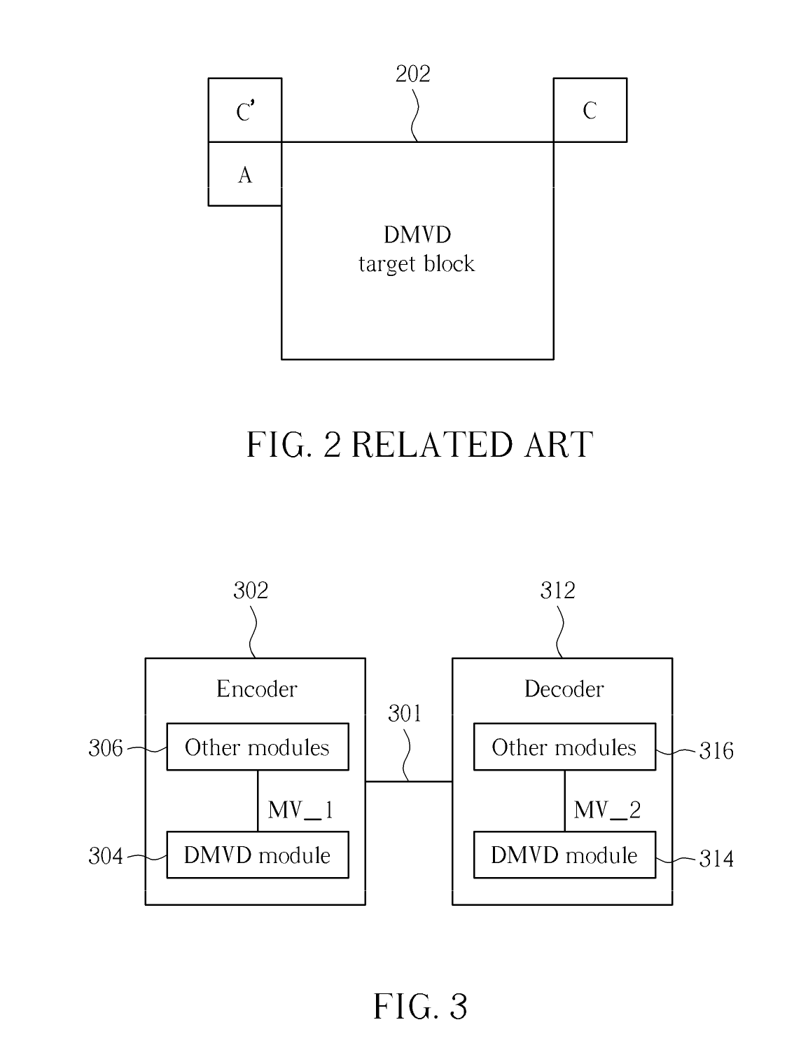

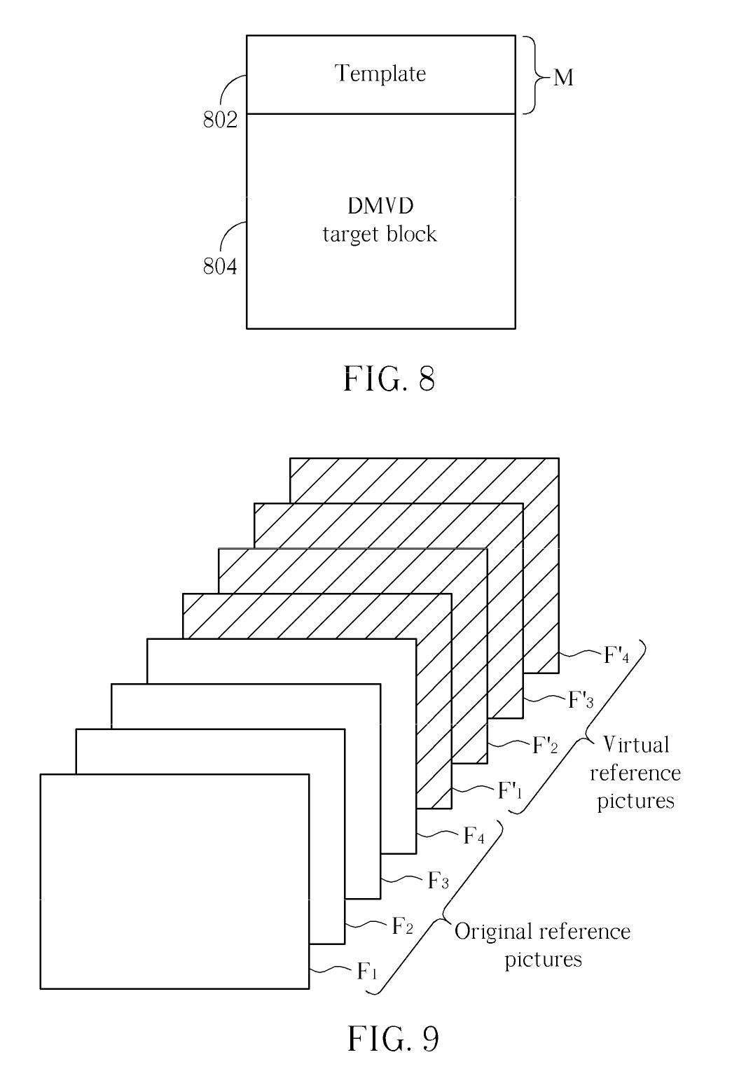

As shown in FIG. 1, the template used in the TM operation is limited to a reverse L-shaped template 104 with a constant template size M. However, the flexibility of the DMVD operation is restricted due to such a template design. In one exemplary design of the present invention, the DMVD module 304/314 is configured to select a template for a DMVD target block, wherein the template and the DMVD target block are located in a same picture, and the template is not a reverse L-shaped template with a constant template size. Next, the DMVD module 304/314 searches at least one reference picture for a final motion vector of the DMVD target block by performing the TM operation according to the particularly designed template. FIG. 7 is a diagram illustrating a first exemplary template design of the present invention. FIG. 8 is a diagram illustrating a second exemplary template design of the present invention. As shown in FIG. 7, the exemplary template is a reverse L-shaped template 702, but the template size thereof is not constant around the DMVD target block. That is, the template 702 is defined by extending M1 pixels from the top of the DMVD target block 704 to form a rectangular template, and extending M2 pixels from the left of the DMVD target block 704 and the rectangular template on the top of the DMVD target block 704, where M1 and M2 are not equal (M1≠M2). As shown in FIG. 8, the exemplary template is a rectangular-shaped template 802 with a template size M. That is, the rectangular-shaped template 802 is defined extending M pixels from the top of the DMVD target block 804. Please note that the above two exemplary templates are for illustrative purposes only, and are not meant to be limitations to the present invention. For example, any template which is not the conventional reverse L-shaped template with a constant template size falls within the scope of the present invention.

Regarding a set of final motion vectors with lowest costs determined for a DMVD target block under a multi-hypothesis prediction, a weighted blending operation may be employed to determine a final prediction block. For example, the DMVD module 304/314 searches one or more reference pictures for a plurality of final motion vectors of a DMVD target block according to a multi-hypothesis prediction, calculates weighting factors of the final motion vectors by referring to distortion values (e.g., SADs or SSDs) respectively corresponding to the final motion vectors, and determines a final prediction block by blending the prediction blocks of final motion vectors according to the calculated weighting factors. The distortion values are derived from a template of a current picture and displaced templates respectively corresponding to the final motion vectors. In one exemplary design, weighting factors of the final motion vectors are inversely proportional to respective distortion values of the final motion vectors. In other words, the lower is a distortion value of a final motion vector, the greater a weighting factor assigned to the final motion vector is.

In another embodiment, a set of candidate motion vectors is allowed to be searched for a DMVD target block under a multi-hypothesis prediction, and a weighted blending operation for template distortion calculation may be employed to determine a final prediction block. For example, when N-hypothesis prediction is considered, the DMVD module 304/314 selects N final motion vectors from the candidate motion vectors, blends N templates of the N final motion vectors according to predefined weighting factors to generate a blended template, and calculates a distortion value between a template of a current picture and the blended template of one or more reference pictures. The final prediction block is blended from N prediction blocks of the N final motion vectors. The DMVD module 304/314 may select two or more different combinations of N final motion vectors to generate a plurality of blended templates, and calculate a plurality of distortion values respectively correspond to the blended templates. A minimum distortion value is then found and the final prediction block is determined by blending prediction blocks corresponding to the N final motion vectors with the minimum distortion value.

To improve the motion estimation accuracy, the present invention further proposes using more reference frames. For example, the DMVD module 304/314 generates at least one virtual reference picture according to at least one original reference picture, and searches the at least one original reference picture and the at least one virtual reference picture for a final motion vector of a DMVD target block. FIG. 9 is a diagram illustrating a plurality of virtual reference pictures F′₁-F′₄ and a plurality of original reference pictures F₁-F₄. It should be noted that the number of created virtual reference pictures can be adjusted according to actual design consideration. Each of the virtual reference pictures F′₁-F′₄ may be created according to one or more original reference pictures. By way of example, but not limitation, the virtual reference pictures F′₁ may be created by applying a specific filtering operation upon one original reference picture, the virtual reference pictures F′₂ may be created by applying a pixel value offset to each pixel within one original reference picture, the virtual reference pictures F′₃ may be created by performing a scaling operation upon one original reference picture, and the virtual reference pictures F′₄ may be created by rotating one original reference picture. As more reference pictures are used in the motion estimation, a more accurate motion vector can be derived. In this way, the coding efficiency is improved accordingly.

In general, the DMVD module 304 of the encoder 302 and the DMVD module 314 of the decoder 312 almost have the same DMVD search burden for determining motion vectors of DMVD target blocks. In one exemplary embodiment, the encoder 302 may be configured to help the decoder 312 to reduce the DMVD search complexity. For example, a DMVD coding operation is performed at the encoder 302, and search control information derived from the DMVD coding operation performed at the encoder 302 is sent to the decoder 312 such that there is asymmetric DMVD search complexity between the encoder 302 and the decoder 312. The search control information may indicate a search space encompassing reference pictures to be searched. Alternatively, the search control information may indicate a search range encompassing reference pictures to be searched, a valid reference picture(s) to be searched, an invalid reference picture(s) that can be skipped for searching, or the search control information may indicate a motion vector refinement operation for a DMVD target block can be skipped. As the encoder 302 provides information to instruct the decoder 312 how to perform the DMVD operation, the DMVD search complexity, such as the template matching complexity, can be effectively reduced.

The present invention also proposes an adaptive DMVD method employed by the DMVD module 304/314, thereby increasing the DMVD flexibility greatly. For example, properties such as the matching criteria (e.g., SAD and SSD), the search position patterns (e.g., full search, various fast search schemes, and enhanced predictive zonal search (EZPS)), the MV precisions (e.g., integer-pel MV precision, ½-pel MV precision, ¼-pel MV precision, and ⅛-pel MV precision), the numbers of hypotheses (e.g., 2 and 4), the template shapes, the blending methods, and the number of virtual reference frames can be adaptively selected in the DMVD operation. Certain exemplary operational scenarios are given as follows.

In regard to a first operational scenario, the DMVD module 304/314 determines a motion vector of a first DMVD target block according to a first matching criterion, and determines a motion vector of a second DMVD target block according to a second matching criterion which is different from the first matching criterion, where a switching between the first matching criterion and the second matching criterion is controlled at one of a sequence level, a group of pictures (GOP) level, a frame level, a picture level, a slice level, a coding unit (macroblock or extended macroblock) level, a prediction unit (macroblock partition or extended macroblock partition) level, and a transform unit level.

In regard to a second operational scenario, the DMVD module 304/314 determines a motion vector of a first DMVD target block according to a first search position pattern, and determines a motion vector of a second DMVD target block according to a second search position pattern which is different from the first search position pattern, where a switching between the first search position pattern and the second search position pattern is controlled at one of a sequence level, a group of pictures (GOP) level, a frame level, a picture level, a slice level, a coding unit (macroblock or extended macroblock) level, a prediction unit (macroblock partition or extended macroblock partition) level, and a transform unit level.

In regard to a third operational scenario, the DMVD module 304/314 determines a motion vector of a first DMVD target block according to a first MV precision, and determines a motion vector of a second DMVD target block according to a second MV precision which is different from the first MV precision, where a switching between the first MV precision and the second MV precision is controlled at one of a sequence level, a group of pictures (GOP) level, a frame level, a picture level, a slice level, a coding unit (macroblock or extended macroblock) level, a prediction unit (macroblock partition or extended macroblock partition) level, and a transform unit level.

In regard to a fourth operational scenario, the DMVD module 304/314 determines a motion vector of a first DMVD target block according to a first number of hypotheses, and determines a motion vector of a second DMVD target block according to a second number of hypotheses different from the first number of hypotheses, where a switching between the first number of hypotheses and the second number of hypotheses is controlled at one of a sequence level, a group of pictures (GOP) level, a frame level, a picture level, a slice level, a coding unit (macroblock or extended macroblock) level, a prediction unit (macroblock partition or extended macroblock partition) level, and a transform unit level.

In regard to a fifth operational scenario, the DMVD module 304/314 determines a motion vector of a first DMVD target block by performing a template matching operation which uses a first template, and determines a motion vector of a second DMVD target block by performing the template matching operation which uses a second template with a template shape different from a template shape of the first template, where a switching between the first template and the second template is controlled at one of a sequence level, a group of pictures (GOP) level, a frame level, a picture level, a slice level, a coding unit (macroblock or extended macroblock) level, a prediction unit (macroblock partition or extended macroblock partition) level, and a transform unit level.

In regard to a sixth operational scenario, the DMVD module 304/314 determines a motion vector of a first DMVD target block by performing a first blending operation upon a plurality of final motion vectors of the first DMVD target block under a multi-hypothesis prediction, and determines a motion vector of a second DMVD target block by performing a second blending operation upon a plurality of final motion vectors of the second DMVD target block under a multi-hypothesis prediction, where the first blending operation and the second blending operation utilize different blending schemes, and a switching between the first blending operation and the second blending operation is controlled at one of a sequence level, a group of pictures (GOP) level, a frame level, a picture level, a slice level, a coding unit (macroblock or extended macroblock) level, a prediction unit (macroblock partition or extended macroblock partition) level, and a transform unit level.

In regard to a seventh operation scenario, the DMVD circuit 304/314 generates at least one first virtual reference picture according to one or a plurality of first reference pictures, searches the first reference picture(s) and the first virtual reference picture(s) for a final motion vector of a first DMVD target block, generates at least one second virtual reference picture according to one or a plurality of second reference pictures, and searches the second reference picture(s) and the second virtual reference picture(s) for a final motion vector of a second DMVD target block, where a number of the first virtual reference picture(s) is different from a number of the second virtual reference picture(s), and a switching between the number of virtual reference picture(s) is controlled at one of a sequence level, a group of pictures (GOP) level, a frame level, a picture level, a slice level, a coding unit (macroblock or extended macroblock) level, a prediction unit (macroblock partition or extended macroblock partition) level, and a transform unit level.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for decoder-side motion vector derivation (DMVD), comprising:
checking a block size of a current block to be encoded and accordingly generating a checking result; and
utilizing a DMVD module to refer to the checking result for controlling conveyance of first DMVD control information which is utilized for indicating whether a DMVD coding operation is employed to encode the current block, wherein when the checking result indicates a predetermined criterion is satisfied, the first DMVD control information is sent in a bitstream; otherwise, the first DMVD control information is not sent.

2. The method of claim 1, wherein the predetermined criterion is satisfied when the block size is found identical to a predetermined block size, and the predetermined block size is a coding unit size selected from 8×8, 16×16, 32×32, 64×64, or 128×128 pixels.

3. The method of claim 1, further comprising:
when the checking result indicates that the predetermined criterion is satisfied, performing a context-adaptive entropy coding operation upon the first DMVD control information of the current block according to first DMVD control information of a plurality of previously coded blocks.

4. The method of claim 3, wherein the context-adaptive entropy coding operation determines a context of the current block as follows:
Context_{—}C=Flag_{—}A+Flag_{—}B; or
Context_{—}C=Flag_{—}A+Flag_{—}B*2; or
Context_{—}C=Flag_{—}A*2+Flag_{—}B,
where Context_C represents the context of the current block, and Flag_A and Flag_B respectively represent the first DMVD control information of the previously coded blocks.

5. The method of claim 1, further comprising:
when the first DMVD control information indicates that the DMVD coding operation is employed, sending second DMVD control information in the bitstream, wherein the second DMVD control information is utilized for indicating whether a DMVD skip mode is employed.

6. The method of claim 5, further comprising:
when the first DMVD control information indicates that the DMVD coding operation is employed, performing a context-adaptive entropy coding operation upon the second DMVD control information of the current block according to second DMVD control information of a plurality of previously coded blocks.

7. The method of claim 6, wherein the context-adaptive entropy coding operation determines a context of the current block as follows:
Context_{—}C=Flag_{—}A+Flag_{—}B; or
Context_{—}C=Flag_{—}A+Flag_{—}B*2; or
Context_{—}C=Flag_{—}A*2+Flag_{—}B,
where Context_C represents the context of the current block, and Flag_A and Flag_B respectively represent the second DMVD control information of the previously coded blocks.

8. The method of claim 1, further comprising:
when the first DMVD control information indicates that the DMVD coding operation is employed, sending second DMVD control information in the bitstream, wherein the second DMVD control information is utilized for indicating whether a specific motion vector (MV) precision, different from a non-DMVD MV precision, is enabled.

9. The method of claim 8, further comprising:
when the first DMVD control information indicates that the DMVD coding operation is employed, performing a context-adaptive entropy coding operation upon the second DMVD control information of the current block according to second DMVD control information of a plurality of previously coded blocks.

10. The method of claim 9, wherein the context-adaptive entropy coding operation determines a context of the current block as follows:
Context_{—}C=Flag_{—}A+Flag_{—}B; or
Context_{—}C=Flag_{—}A+Flag_{—}B*2; or
Context_{—}C=Flag_{—}A*2+Flag_{—}B,
where Context_C represents the context of the current block, and Flag_A and Flag_B respectively represent the second DMVD control information of the previously coded blocks.

11. A method for decoder-side motion vector derivation (DMVD), comprising:
utilizing a DMVD module to set a DMVD target block size of a DMVD target block by referring to a transform block size for a current block, wherein the DMVD target block size is consistent with the transform block size; and
determining a final motion vector of the DMVD target block within the current block.

12. A method for decoder-side motion vector derivation (DMVD), comprising:
setting a DMVD motion vector (MV) precision by a DMVD module, comprising:
enabling a specific MV precision as the DMVD MV precision, wherein the specific MV precision is different from a non-DMVD MV precision; and
determining a final motion vector of a DMVD target block according to the DMVD MV precision.

13. The method of claim 12, wherein the specific MV precision is higher than any non-DMVD MV precision.

14. The method of claim 13, further comprising:
adjusting the final motion vector by truncating the specific MV precision of the final motion vector to the non-DMVD MV precision, and accordingly generating a resultant motion vector with the non-DMVD MV precision.

15. The method of claim 12, wherein the specific MV precision is enabled at a slice level or a sequence level.

16. The method of claim 12, wherein setting the DMVD MV precision comprises:
setting the DMVD MV precision according to a resolution of an input video;
wherein the specific MV precision is enabled as the DMVD MV precision for the input video with a first resolution; and a non-DMVD MV precision is enabled as the DMVD MV precision for the input video with a second resolution higher than the first resolution.

17. A method for decoder-side motion vector derivation (DMVD), comprising:
utilizing a DMVD module to select motion vectors of coded blocks for a DMVD target block;
processing the motion vectors of the coded blocks to compute a candidate motion vector; and
determining a final motion vector of the DMVD target block according to at least the candidate motion vector.

18. The method of claim 17, wherein the candidate motion vector is a median of the motion vectors of the coded blocks.

19. The method of claim 17, further comprising:
utilizing the DMVD module to select a motion vector of at least one block as another candidate motion vector of the DMVD target block, and determining the final motion vector of the DMVD target block according to the candidate motion vectors.

20. The method of claim 19, wherein the at least one block and the DMVD target block are located in different pictures.

21. A method for decoder-side motion vector derivation (DMVD), comprising:
utilizing a DMVD module to select a motion vector of at least one block as a candidate motion vector of a DMVD target block, wherein the at least one block and the DMVD target block are located in different pictures; and
determining a final motion vector of the DMVD target block according to at least the candidate motion vector.

22. A method for decoder-side motion vector derivation (DMVD), comprising:
utilizing a DMVD module to select a template for a DMVD target block, wherein the template and the DMVD target block are located in a same picture, and the template is a rectangular-shaped template defined by extending M pixels from the top of the DMVD target block; and
searching at least one reference picture for a final motion vector of the DMVD target block by performing a template matching operation according to the template.

23. The method of claim 22, wherein the template further comprises M2 pixels extended from the left of the DMVD target block and the rectangular-shaped template, and M2 and M are not equal.

24. A method for decoder-side motion vector derivation (DMVD), comprising:
searching at least one reference picture for a plurality of final motion vectors of a DMVD target block according to a multi-hypothesis prediction;
utilizing a DMVD module to calculate weighting factors of the final motion vectors by referring to distortion values respectively corresponding to the final motion vectors; and
determining a final prediction block by blending prediction blocks of the final motion vectors according to the calculated weighting factors.

25. The method of claim 24, wherein the distortion values are derived from a template of a current picture and displaced templates respectively corresponding to the final motion vectors.

26. A method for decoder-side motion vector derivation (DMVD), comprising:
searching at least one reference picture for a plurality of candidate motion vectors of a DMVD target block according to a multi-hypothesis prediction;
utilizing a DMVD module to select multiple final motion vectors from the plurality of candidate motion vectors, blend multiple templates of the multiple final motion vectors according to predefined weighting factors to generate a blended template, and calculate a distortion value between a template of a current picture and the blended template of the at least one reference picture; and
determining a final prediction block by blending prediction blocks of the multiple final motion vectors.

27. The method of claim 26, wherein the DMVD module generates a plurality of blended templates and calculates a plurality of distortion values by selecting different combinations of multiple final motion vectors, and the final prediction block is determined by blending prediction blocks corresponding to the multiple final motion vectors with a minimum distortion value.

28. A method for decoder-side motion vector derivation (DMVD), comprising:
utilizing a DMVD module to generate at least one virtual reference picture according to at least one original reference picture; and
searching the at least one original reference picture and the at least one virtual reference picture for a final motion vector of a DMVD target block.

29. The method of claim 28, wherein the virtual reference picture is created by applying a specific filtering operation upon the at least one original reference picture, applying a pixel value offset to pixels of the at least one original reference picture, performing a scaling operation upon the at least one original picture, or rotating the at least one original reference picture.

30. A method for decoder-side motion vector derivation (DMVD), comprising:
performing a DMVD coding operation at an encoder; and
sending search control information derived from the DMVD coding operation performed at the encoder to a decoder such that there is asymmetric DMVD search complexity between the encoder and the decoder.

31. The method of claim 30, wherein the search control information indicates a search space or search range encompassing reference pictures to be searched.

32. The method of claim 30, wherein the search control information indicates skipping a motion vector refinement operation for a DMVD target block.

33. A method for decoder-side motion vector derivation (DMVD), comprising:
utilizing a DMVD module to determine a motion vector of a first DMVD target block according to a first property; and
utilizing the DMVD module to determine a motion vector of a second DMVD target block according to a second property different from the first property.

34. The method of claim 33, wherein a switching between the first property and the second property is controlled at one of a sequence level, a group of pictures (GOP) level, a frame level, a picture level, a slice level, a coding unit level, a prediction unit level, and a transform unit level.

35. The method of claim 33, wherein the first property and second property are different matching criteria.

36. The method of claim 33, wherein the first property and second property are different search position patterns.

37. The method of claim 33, wherein the first property and second property are different motion vector precisions.

38. The method of claim 33, wherein the first property and second property are different numbers of hypotheses.

39. The method of claim 33, wherein the first property and second property are different template shapes for a template matching operation.

40. The method of claim 33, wherein the first property and second property are different blending schemes for a multi-hypothesis prediction.

41. The method of claim 33, wherein the first property and second property are different numbers of virtual reference pictures.
